(19) United States
(12) Patent Application Publication
(10) Pub. No.: US 2022/0284504 A1
(43) Pub. Date: Sep. 8, 2022

(54) INFORMATION PROCESSING DEVICE AND INFORMATION PROCESSING SYSTEM

(71) Applicant: TOSHIBA TEC KABUSHIKI KAISHA, Tokyo (JP)

(72) Inventor: Takahide KUBOTA, Mishima Shizuoka (JP)

(73) Assignee: TOSHIBA TEC KABUSHIKI KAISHA, Tokyo (JP)

(21) Appl. No.: 17/560,694

(22) Filed: Dec. 23, 2021

(30) Foreign Application Priority Data
Mar. 2, 2021 (JP) 2021-032844

(51) Int. Cl. G06Q 30/06; G06V 20/52; G01C 21/20; G01C 21/34

(52) U.S. Cl. CPC G06Q 30/0639; G06V 20/53; G01C 21/206; G01C 21/3492; G06Q 30/0631

(57) ABSTRACT

An information processing device includes a first acquisition unit, a first specifying unit, a second acquisition unit, a route generation unit, and an output unit. The first acquisition unit acquires information relating to at least one merchandise to be purchased based on input of a user. The first specifying unit specifies an area of the at least one merchandise to be purchased based on the information relating to the at least one merchandise to be purchased that is acquired by the first acquisition unit. The second acquisition unit acquires congestion information per area in a store. The route generation unit generates a route based on the area of the at least one merchandise to be purchased that is specified by the first specifying unit and the congestion information that is acquired by the second acquisition unit. The output unit outputs the route that is generated by the route generation unit.

### CROSS-REFERENCE TO RELATED APPLICATION

This application is based upon and claims the benefit of priority from Japanese Patent Application No. 2021-032844, filed on Mar. 2, 2021, the entire contents of which are incorporated herein by reference.

### FIELD

Embodiments described herein relate generally to an information processing device and an information processing system.

### BACKGROUND

In commercial facilities, customers may be concentrated and congested in a specific area depending on a time zone. Various measures are taken to avoid congestion in commercial facilities for the purpose of preventing the spread of infectious diseases caused by pathogens such as viruses. For example, a technique for promoting a congestion situation in a store or a congestion situation around a counter to a customer is known.

### DESCRIPTION OF THE DRAWINGS

FIG. 1 is a block diagram illustrating an information processing system according to a first embodiment;

FIG. 2 is a diagram illustrating an example of a route;

FIG. 3 is a diagram illustrating another example of the route;

FIG. 4 is a flowchart illustrating a procedure of information processes by a server;

FIG. 5 is a diagram illustrating an example of a route according to a second embodiment; and

FIG. 6 is a flowchart illustrating a procedure of information processes by a server.

### DETAILED DESCRIPTION

In the promotion of the congestion situation, a method of actively avoiding congestion cannot be provided for the customers.

An object to be solved by exemplary embodiments is to provide a technique that enables a purchase route based on the congestion situation.

In general, according to at least one embodiment, an information processing device includes a first acquisition unit, a first specifying unit, a second acquisition unit, a route generation unit, and an output unit. The first acquisition unit acquires information relating to at least one merchandise to be purchased based on input of a user. The first specifying unit specifies an area of the at least one merchandise to be purchased based on the information relating to the at least one merchandise to be purchased that is acquired by the first acquisition unit. The second acquisition unit acquires congestion information per area in a store. The route generation unit generates a route based on the area of the at least one merchandise to be purchased that is specified by the first specifying unit and the congestion information that is acquired by the second acquisition unit. The output unit outputs the route that is generated by the route generation unit.

### First Embodiment

Hereinafter, embodiments are described with reference to the drawings. In each drawing, the same components are denoted by the same reference numerals as much as possible, and overlapping description is omitted.

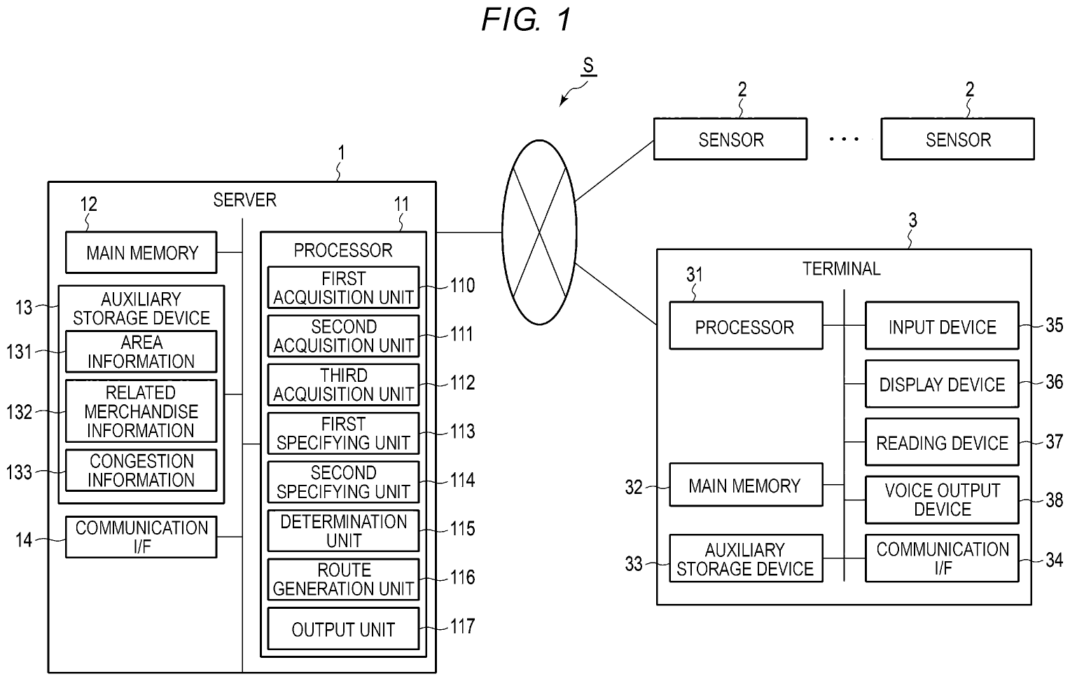

FIG. 1 is a block diagram illustrating an information processing system S according to a first embodiment. The information processing system S includes a server 1, a plurality of sensors 2, and a terminal 3. The server 1, the sensors 2, and the terminal 3 are connected to each other via a network in a freely communicable manner. For example, the network is a Local Area Network (LAN). The network may include a wireless network and may include a wired network. In addition, the information processing system S may refer to a system including at least two devices among the server 1, the sensors 2, and the terminal 3.

The server 1 is an electronic device that collects data and processes the collected data. The server 1 is connected to the sensors 2 and the terminal 3 via the network in a freely communicable manner. The sensors 2 and the terminal 3 are used, for example, in a commercial facility such as a store. The server 1 receives various kinds of data from the sensors 2 or the terminal 3 and outputs a data processing result to the terminal 3. The server 1 is an example of the information processing device. A configuration example of the server 1 is described below.

The plurality of sensors 2 detect positions of a plurality of users who enter the store, respectively. The sensors 2 are attached, for example, to the ceiling of the store. The sensors 2 may be provided, for example, along the customer aisle in the store. As the sensor 2, a well-known camera sensor such as an optical camera, an infrared camera, a Time of Flight (TOF) camera, or a stereo camera can be used. Further, beacon terminals that transmit a beacon signal including an ID by radio waves may be disposed in various places in the store, and the server 1 may detect a position of the user in combination with the terminal 3 possessed by the user. The position information of the user detected by using the sensor 2 or the beacon signal may be collected and stored in the server 1 in chronological order as position information data together with the detection date and time. The user may be also read as a customer, a purchaser, or a person.

The terminal 3 is an electronic device that can communicate with other electronic devices. The terminal 3 is, for example, a device used by a user who enters the store. The terminal 3 is, for example, a smartphone or a tablet terminal. The terminal 3 is an example of an information processing terminal. A configuration example of the terminal 3 is described below.

A configuration example of the server 1 is described.

The server 1 is an electronic device including a processor 11, a main memory 12, an auxiliary storage device 13, and a communication interface 14. Each unit that configures the server 1 is connected to be capable of input and output a signal to and from each other. In FIG. 1, the interface is described as “I/F”.

The processor 11 corresponds to a central portion of the server 1. For example, the processor 11 is a Central Processing Unit (CPU), but is not limited thereto. The processor 11 may be configured with various circuits. The processor 11 loads a program stored in advance in the main memory 12 or the auxiliary storage device 13 in the main memory 12. The program is a program that causes the processor 11 of the device 1 to realize or execute each unit described below. The processor 11 performs various operations by executing the program loaded in the main memory 12.

The main memory 12 corresponds to the main storage portion of the server 1. The main memory 12 includes a non-volatile memory area and a volatile memory area. The main memory 12 stores an operating system or a program in the non-volatile memory area. The main memory 12 uses a volatile memory area as a work area in which data is appropriately rewritten by the processor 11. For example, the main memory 12 includes a Read Only Memory (ROM) as the non-volatile memory area. For example, the main memory 12 may include a Random Access Memory (RAM) as the volatile memory area. The main memory 12 stores a program.

The auxiliary storage device 13 corresponds to an auxiliary storage portion of the server 1. The auxiliary storage device 13 is an Electric Erasable Programmable Read-Only Memory (EEPROM) (Registered Trademark), a Hard Disc Drive (HDD), a Solid State Drive (SSD), or the like. The auxiliary storage device 13 stores the program described above, data used for performing various processes by the processor 11, and data generated by a process in the processor 11. The auxiliary storage device 13 stores the program described above.

The auxiliary storage device 13 stores area information 131, related merchandise information 132, and congestion information 133.

The area information 131 includes a record that configures data obtained by correlating merchandise identification information, area identification information of an area where each merchandise is displayed, and display position information of the display of each merchandise. Each record included in the area information 131 corresponds to area information. The merchandise identification information is unique identification information that is assigned on a per merchandise item basis in order to identify each merchandise. The merchandise identification information may be assigned on a per merchandise item basis or may be assigned on a per merchandise category basis or on a per merchandise article basis. The area where each merchandise is displayed is a section including a position of a display shelf where each merchandise is displayed. The position of the display shelf where each merchandise is displayed is also referred to as a position of the merchandise. The section is a section in which the floor area in the store is divided by a certain area. The area where the merchandise is displayed is referred to as an area of the merchandise or an area. The area is also referred to as a section, a bloc, or a region. The description is made with reference to an example in which each area is the same rectangle, but the shape and size of each area may be different. The area identification information is unique identification information assigned on a per area basis in order to identify each area. The display position information is information indicating the position of the display shelf where each merchandise is displayed. The display position information is information indicating the position of the merchandise.

The related merchandise information 132 includes a record that configures data obtained by correlating the merchandise identification information and the information of the related merchandise. Each record included in the related merchandise information 132 corresponds to the related merchandise information. The related merchandise is a merchandise relating to each merchandise. The related merchandise is, for example, a merchandise that is suggested to be purchased to the customer who purchases each merchandise. The related merchandise is also referred to as a suggested merchandise. For example, the related merchandise may be a seasoning used for each merchandise, a merchandise cooked at the same time as each merchandise, a merchandise often purchased at the same time as each merchandise, or the like. For example, related merchandises of bread may be butter, cheese, jam, eggs, ham, and coffee. The related merchandises of chicken may be flour, salt, pepper, seasonings for chicken dishes, and the like. At least one related merchandise may be assigned to each merchandise, and a common related merchandise may be assigned to a plurality of merchandises. The information of the related merchandise includes merchandise identification information of the related merchandise, recommended information of the related merchandise, and the like. The recommended information may include features of the merchandise, discount information, review information, and the like. The information of the related merchandise corresponds to the information relating to the related merchandise.

The congestion information 133 includes a record that configures data obtained by correlating the area identification information and congestion information per area. Each record included in the congestion information 133 corresponds to the congestion information. The congestion information is information indicating a congestion degree of customers per area. The congestion degree is, for example, a value obtained by calculating the density of customers per area. The density of the customer is, for example, calculated by summing up the number of customers in each area. The number of customers may be summed up based on the position information of customers detected by using the sensors 2 or beacon signals. The congestion degree may be determined based on a threshold value defined in advance in relation to the number of customers in the area. For example, the congestion degree is determined by classifying the value calculated based on the data detected by using the sensors 2 or the beacon signals into a plurality of levels such as three levels. For example, if the number of customers per square meter is 0 to 0.4, it is determined as “Level 1”, if the number of customers per square meter is 0.5 to 0.7, it is determined as “Level 2”, and if the number of customers per square meter is 0.8 or more, it is determined as “Level 3”. For example, “Level 1” indicates that the congestion degree is low, and “Level 3” indicates that the congestion degree is high. The congestion degree may be the density of customers. The congestion degree is an example of the congestion information. The congestion degree may be a current congestion degree and may be predicted from the current congestion degree. The determination of the congestion degree may be determined by a well-known determination method. The congestion information 133 may be updated whenever the congestion degree is determined. The congestion information 133 may be updated whenever the position information of the customers is detected. The congestion information 133 may be updated at a certain time interval set in advance.

The congestion information 133 is based on the process of the processor 11 as illustrated below. The processor 11 acquires the position information of the plurality of customers in the store detected by using the sensors 2 or the beacon signals via the network. The processor 11 may acquire the position information of the plurality of customers at a certain time interval set in advance. The processor 11 sums up the number of customers in each area based on the acquired position information of the plurality of customers and the position information of each area identified with the area identification information. The processor 11 calculates the density of the customers in each area based on the summed number of customers in each area. The processor 11 determines the congestion degree in each area based on the calculated density of the customers in each area. The processor 11 may compare the calculated density of the customers in each area with the threshold value correlated with each level described above. The processor 11 may determine the congestion degree in each area by the level based on the comparison result. The processor stores the congestion information 133 obtained by correlating the information indicating the determined congestion degree in each area with the area identification information, in the auxiliary storage device 13. The processor 11 updates the information indicating the congestion degree in each area among the congestion information 133 stored in the auxiliary storage device 13 based on the process whenever the position information of the plurality of customers is acquired.

The communication interface 14 includes various interfaces that communicably connect the server 1 to the other electronic devices via the network according to a predetermined communication protocol.

The hardware configuration of the server 1 is not limited to the configuration described above. In the server 1, the above components can be appropriately omitted or changed and new components can be added.

Each unit installed in the processor 11 described above is described.

The processor 11 includes a first acquisition unit 110, a second acquisition unit 111, a third acquisition unit 112, a first specifying unit 113, a second specifying unit 114, a determination unit 115, a route generation unit 116, and an output unit 117 installed thereto. Each unit installed in the processor 11 can be also referred to as each function. Each unit installed in the processor 11 can be installed in the control unit including the processor 11 and the main memory 12.

The first acquisition unit 110 acquires the information relating to the merchandise to be purchased based on the input of the user from the terminal 3 via the communication interface 14. The merchandise to be purchased is a merchandise to be purchased by the user in the store. The merchandise to be purchased is a merchandise that can be identified by the merchandise identification information. The merchandise to be purchased is input by the user via an input device 35 of the terminal 3 prior to the purchase in the store. The user starts a dedicated application program in the terminal 3 in advance and registers as a member. The user who completes the member registration inputs the merchandise to be purchased via the input device 35 according to the application program. The user who is registered as a member in advance may log in the dedicated application program and input the merchandise to be purchased via the input device 35. The merchandise to be purchased may be a merchandise on a shopping list. A merchandise that the user actually acquires in the store is removed from the merchandise to be purchased. The acquisition of the merchandise by the user includes the meanings of “registering the merchandise”, “obtaining the merchandise”, “putting the merchandise into a shopping bag”, and the like.

The second acquisition unit 111 acquires the congestion degree per area in the store from the congestion information 133.

The third acquisition unit 112 acquires the information relating to the related merchandise from the related merchandise information 132.

The first specifying unit 113 refers to the area information 131 based on the information relating to the merchandise to be purchased that is acquired by the first acquisition unit 110 to specify the area of the merchandise to be purchased. The first specifying unit 113 specifies the area of the merchandise to be purchased based on the area identification information correlated with the merchandise to be purchased.

The second specifying unit 114 refers to the area information 131 based on the information relating to the related merchandise acquired by the third acquisition unit 112 to specify the area of the related merchandise. The second specifying unit 114 specifies the area of the related merchandise based on the area identification information correlated with the related merchandise.

The determination unit 115 determines the recommended merchandise from the related merchandises based on the area of the related merchandises specified by the second specifying unit 114 and the congestion degree acquired by the second acquisition unit 111. The recommended merchandise is a related merchandise selected from the related merchandises and promoted to the customer. For example, the recommended merchandise is a related merchandise displayed in an area where the congestion degree is not high. The area where the congestion degree is not high may be an area where the congestion degree is less than the threshold value.

The route generation unit 116 generates the route based on the area of the merchandise to be purchased specified by the first specifying unit 113 and the congestion degree acquired by the second acquisition unit 111. The route is a path or pathway in which the customer moves in the store in order to acquire the merchandise. The route has a store entrance as a starting point and a counter as a goal point. The route may be a route that has the current location of the customer as the starting point. The route may be a route for acquiring the merchandise to be purchased and a route for acquiring the recommended merchandise in addition to the merchandise to be purchased. The route generation unit 116 may update the route by the operation of the user. The operation of the user may include input by the user via the input device 35 and a reading operation by the user via a reading device 37. The generation of the route includes the update of the route.

The output unit 117 outputs the route generated by the route generation unit 116 to the terminal 3 via the communication interface 14. The output unit 117 outputs the information relating to the recommended merchandise determined by the determination unit 115 to the terminal 3 via the communication interface 14. The output unit 117 may output at least one of the route and the information relating to the recommended merchandise. The output unit 117 may change an output mode of the recommended merchandise in response to whether the area of the recommended merchandise is close to the route. The fact that the area of the merchandise is close to the route corresponds to the fact that the area of the merchandise is within the predetermined field from the route. In the description below, “outputting” may be also read as “transmitting”.

A configuration example of the terminal 3 is described.

The terminal 3 is an electronic device including a processor 31, a main memory 32, an auxiliary storage device 33, a communication interface 34, the input device 35, a display device 36, and the reading device 37. Each unit that configures the terminal 3 is connected to be capable of inputting and outputting a signal to and from each other.

The processor 31 corresponds to a central portion of the terminal 3. The hardware configuration of the processor 31 is the same configuration as the processor 11 described above. The processor 31 performs various operations by executing various programs stored in the main memory 32 or the auxiliary storage device 33 in advance.

The main memory 32 corresponds to the main storage portion of the terminal 3. The hardware configuration of the main memory 32 is the same configuration as the main memory 12 described above. The main memory 32 stores a program.

The auxiliary storage device 33 corresponds to an auxiliary storage portion of the terminal 3. The hardware configuration of the auxiliary storage device 33 is the same configuration as the auxiliary storage device 13 described above. The auxiliary storage device 33 stores the program described above.

The communication interface 34 includes various interfaces that communicably connect the terminal 3 to other devices via a network according to a predetermined communication protocol.

The input device 35 is a device that can input data or instructions to the terminal 3. For example, the input device 35 is a keyboard or a touch panel. The input device 35 may include a microphone that enables voice input.

The display device 36 is a device that can display various screens by the control of the processor 31. For example, the display device 36 is a liquid crystal display or an Electroluminescence (EL) display.

The reading device 37 is a device that can read various kinds of data. For example, the reading device 37 includes a scanner that can read data from the code symbol. The code symbol is a two-dimensional code symbol such as a barcode symbol and a QR code (Registered Trademark). The reading device 37 is an image capturing device such as a camera that can read data from the code symbol. The camera may be a type that reads a code symbol by scanning a laser beam or may be a type that reads a code symbol from an image captured by an image capturing device. For example, the reading device 37 reads the code symbol attached to the merchandise and registers the purchased merchandise.

A voice output device 38 is a device that can output a sound according to the control of the terminal 3.

The hardware configuration of the terminal 3 is not limited to the configuration described above. In the terminal 3, the above components can be appropriately omitted or changed, and new components can be added.

The route displayed on the display device 36 is described.

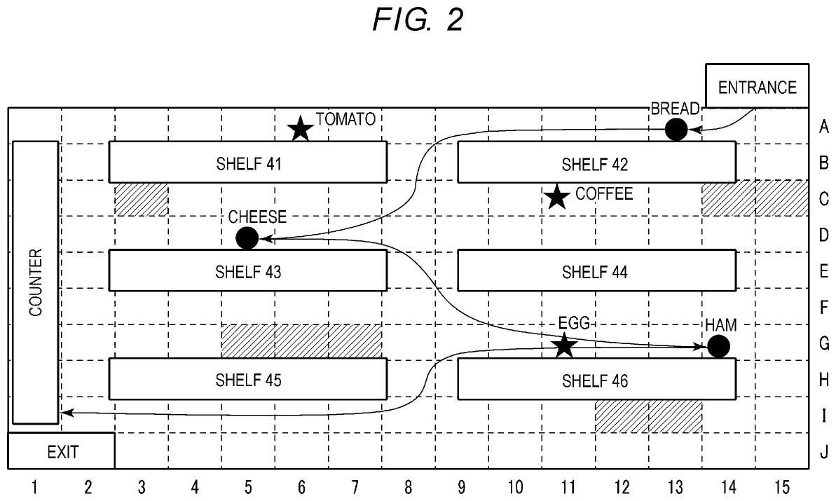

FIG. 2 is a diagram illustrating an example of the route according to the first embodiment.

FIG. 2 is an example of the route displayed on the display device 36 of the terminal 3. The route displayed on the display device 36 is a route output by the output unit 117. The output unit 117 outputs a schematic diagram of the inside of the store including the route to the display device 36. The output unit 117 outputs the congestion degree per area to the display device 36 in an identifiable manner.

FIG. 2 is a schematic diagram of the inside of the store. As illustrated in FIG. 2, the inside of the store is divided by areas obtained by dividing the floor area in the store by a certain area. For example, the area with a high congestion degree in the store is identifiably illustrated. In the example of FIG. 2, the area with a high congestion degree is indicated with diagonal lines. In FIG. 2, the black circle indicates the merchandise to be purchased by the user of the terminal 3. For example, the route generation unit 116 generates the route for acquiring the merchandise to be purchased by the user. In an example, the route generation unit 116 generates the route that avoids the areas with the high congestion degrees. In FIG. 2, the route generated by the route generation unit 116 is indicated with arrows. Stars indicate recommended merchandises. For example, the determination unit 115 determines a related merchandise displayed in the area where the congestion degree is not high from the related merchandises of the merchandise to be purchased as a recommended merchandise. A recommended merchandise determination process is described below. In FIG. 2, the recommended merchandises determined by the determination unit 115 are indicated with stars. In an example, the determination unit 115 determines the recommended merchandises without comparing the route and the positions of the areas of the recommended merchandises. The recommended merchandises correspond to the recommended merchandises to be output. As illustrated in FIG. 2, the recommended merchandise displayed in the area within the predetermined field from the route and the recommended merchandises displayed in areas out of the area within the predetermined field from the route are displayed. The area within the predetermined field is, for example, within a radius of 2 meters or within a radius of 5 meters from each position on the route. With respect to the predetermined field, areas through which the route passes may be referred to as fields. With respect to the predetermined field, areas through which the route passes, and areas through which the route does not pass and which are adjacent to areas through which the route passes may be referred to as fields. With respect to the predetermined field, areas from areas through which the route pass to areas where one or more areas through which the route does not pass are interposed therebetween may be referred to as fields. The predetermined field may be set in advance or may be appropriately updated.

As a specific example, a case where the merchandises to be purchased by the user of the terminal 3 are “bread”, “ham”, and “cheese” is described. The route generation unit 116 generates a route for acquiring the “bread”, the “ham”, and the “cheese”. The route generation unit 116 generates the route that avoids the areas with high congestion degrees. The route generation unit 116 first determines the “bread” displayed in an area that is the closest to the store entrance, which is the current location of the user, and in the area where the congestion degree is not high, as a first point. Subsequently, the route generation unit 116 determines the “cheese” displayed in an area that is close to the first point “bread” through the route that avoids an area with a high congestion degree, as a second point. In order to avoid areas C-14 and C-15 with the high congestion degrees, the route generation unit 116 generates a route that does not pass the areas C-14 and C-15. Subsequently, the route generation unit 116 generates a route that connects the second point “cheese” to the final point “ham” through the route that avoids areas with high congestion degrees. The route generation unit 116 generates a route that is from the final point “ham” to the counter and avoids areas with high congestion degrees. Here, in order to avoid areas G-5, G-6, and G-7 with high congestion degrees, the route generation unit 116 generates a route that does not pass the areas G-5, G-6, and G-7. As above, the route generation unit 116 generates a route that connects the points of the “bread”, the “ham”, and the “cheese” and avoids the areas with the high congestion degrees. The route generated by the route generation unit 116 can be a route different from the shortest route that connects each of the points.

In the example, the third acquisition unit 112 acquires information relating to the related merchandises of the “bread”, the “ham”, and the “cheese” that are the merchandises to be purchased by the user of the terminal 3. The determination unit 115 determines the related merchandises displayed in the areas where the congestion degrees are not high from the respective related merchandises as recommended merchandises. In the example, the determination unit 115 determines “tomatoes”, “coffee”, and “eggs” as the recommended merchandises. In FIG. 2, the “tomatoes”, the “coffee”, and the “eggs” are displayed as the recommended merchandises. In the example, the “tomatoes” and the “coffee” displayed in areas out of the route and the “eggs” displayed in an area close to the route are displayed together.

In the example, the display device 36 can display a route for acquiring the merchandises to be purchased by the user while avoiding the areas with the high congestion degrees. Therefore, the user can acquire the merchandises while avoiding the areas with the high congestion degrees by moving along the route. The display device 36 can display the information of the recommended merchandises displayed in the areas where the congestion degrees are not high among merchandises relating to the merchandises to be purchased by the user. Therefore, if the user is interested in the recommended merchandises, the user goes out of the route to acquire the recommended merchandises but can avoid the areas with the high congestion degrees.

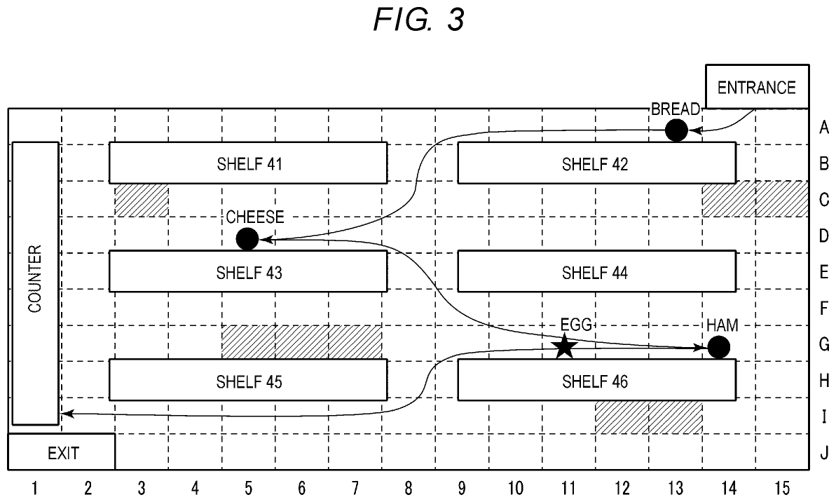

FIG. 3 is a diagram illustrating another example of the route according to the first embodiment.

FIG. 3 illustrates another example of the route displayed on the display device 36 of the terminal 3. The route displayed on the display device 36 is a route output by the output unit 117.

In the same manner as in FIG. 2, FIG. 3 illustrates the schematic diagram of the inside of the store and the areas with the high congestion degrees are identifiably indicated. In FIG. 3, black circles indicate the merchandises to be purchased by the user of the terminal 3. The route generation process by the route generation unit 116 is the same as the process in the example of FIG. 2. A star indicates a recommended merchandise. For example, the determination unit 115 determines a related merchandise displayed in an area where a congestion degree is not high among related merchandises of the merchandise to be purchased as a merchandise to be recommended. In the example, the determination unit 115 compares the route and the position of the area of the merchandise to be recommended. The determination unit 115 determines the merchandise to be recommended that is displayed in the area within the predetermined field from the route as the recommended merchandise. The recommended merchandise determination process is described below. The recommended merchandise corresponds to a recommended merchandise to be output. The merchandise to be recommended corresponds to the recommended merchandise in the example of FIG. 2. As illustrated in FIG. 3, only the recommended merchandise displayed in the area within the predetermined field from the route is displayed.

As a specific example, in the same manner as in the example of FIG. 2, a case where the merchandises to be purchased by the user of the terminal 3 are the “bread”, the “ham”, and the “cheese” is described. In the same manner as in the example of FIG. 2, the route generation unit 116 generates a route for acquiring the “bread”, the “ham”, and the “cheese”.

The third acquisition unit 112 acquires information relating to the related merchandises of the “bread”, the “ham”, and the “cheese” that are the merchandises to be purchased by the user of the terminal 3. The determination unit 115 determines the related merchandises displayed in the areas where the congestion degrees are not high among the related merchandises as the merchandise to be recommended. In the example, the determination unit 115 determines the “tomatoes”, the “coffee”, and the “eggs” as the merchandises to be recommended. Further, the determination unit 115 determines the recommended merchandises displayed in the area within the predetermined field from the route among the “tomatoes”, the “coffee”, and the “eggs”. In the example, the determination unit 115 determines the “eggs” as the recommended merchandise. In FIG. 3, only the “eggs” displayed in the area within the predetermined field from the route is displayed as the recommended merchandise.

According to the example, the display device 36 can display the route for acquiring the merchandises to be purchased by the user and the information of the recommended merchandise displayed in the area where the congestion degree is not high within the predetermined field from the route. Therefore, if the user is interested in the recommended merchandise, the user can acquire the recommended merchandise without going out of the route that avoids the areas with the high congestion degrees.

The procedure of the processes by the information processing system S is described.

In the following description with the server 1 as a subject, the server 1 may be read as the processor 11. In the same manner, in the description with the terminal 3 as a subject, the terminal 3 may be read as the processor 31. The processing procedure described below is merely an example, and each process may be changed as much as possible. In the processing procedure described below, steps can be appropriately omitted, substituted, or added in response to the embodiments.

Here, a case where the user of the terminal 3 intends to purchase “bread”, “ham”, and “cheese” in a store A that handles fresh foods such as a supermarket is assumed. It is assumed that the user completes the member registration in the dedicated application program. If the user is registered as a member, a unique member ID is issued to the user. The member ID is set, for example, to the terminal 3 owned by the user. Prior to the purchase in the store A, the user inputs the merchandises to be purchased, the “bread”, the “ham”, and the “cheese” to the terminal 3 via the input device 35. The merchandises to be purchased may be a category of a merchandise such as bread and chicken, may be an article of a merchandise, or a merchandise name such as “XX bread”. In addition, the merchandise to be purchased may be a merchandise to be freely input by the user, and may be a merchandise selected by the user from the plurality of merchandises promoted by an application program.

The user checks in via a check-in device provided at the entrance of the store A. For example, if the user starts a dedicated application program in the terminal 3, a barcode, a two-dimensional code, or the like that indicates a member ID is displayed on the display device 36. The user reads the member ID and checks in via the check-in device. The member ID may be recorded in Radio Frequency Identification (RFID), an IC card, a magnetic card, or the like. The check-in with the member ID may be performed by a well-known process.

When the user checks in, the sensor 2 detects the position of the user. The sensors 2 are provided in the store A. The user reads the code symbol attached to the merchandise displayed in the store A via the reading device 37 and registers the purchased merchandise.

The server 1 performs the following information process in response to the check-in by the user. In the following description, the expression “in response to” may be read as the expression “based on”.

The procedure of the information processes by the server 1 is described.

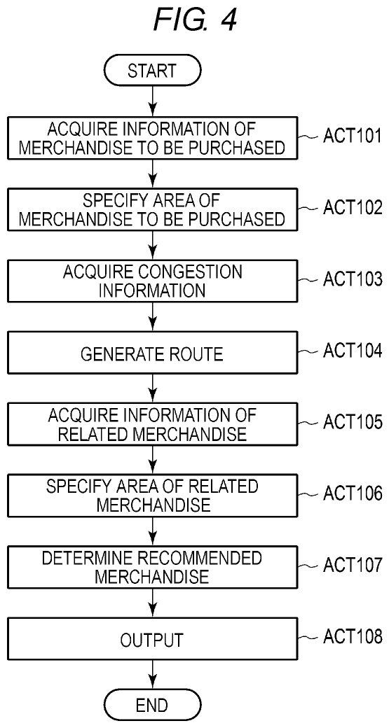

FIG. 4 is a flowchart illustrating the procedure of the information processes by the server 1 according to the first embodiment.

The first acquisition unit 110 acquires information relating to at least one merchandise to be purchased based on the input of the user from the terminal 3 via the communication interface 14 (ACT 101). In ACT 101, for example, the first acquisition unit 110 acquires the merchandise identification information correlated with the at least one merchandise to be purchased. The first acquisition unit 110 may acquire the merchandise identification information correlated with each merchandise to be purchased. The first acquisition unit 110 may acquire the category of each merchandise to be purchased and the merchandise identification information correlated with the article of the merchandise.

The first specifying unit 113 specifies the area of at least one merchandise to be purchased based on the information relating to the at least one merchandise to be purchased that is acquired by the first acquisition unit 110 (ACT 102). In ACT 102, for example, the first specifying unit 113 refers to the area information 131 and acquires display position information and area identification information based on the merchandise identification information correlated with the merchandise to be purchased. The first specifying unit 113 specifies the area of the merchandise to be purchased based on the area identification information.

The second acquisition unit 111 refers to the congestion information 133 and acquires the congestion degree per area in the store (ACT 103).

The route generation unit 116 generates the route based on the area of at least one merchandise to be purchased specified by the first specifying unit 113 and the congestion degree acquired by the second acquisition unit 111 (ACT 104). In ACT 104, for example, the route generation unit 116 compares the congestion degree of the area of the at least one merchandise to be purchased with the threshold value. The route generation unit 116 determines an order for acquiring the merchandises to be purchased based on the current location of the user detected by using the sensors 2 or the beacon signals from among the merchandises to be purchased that are displayed in the area where the congestion degree is less than the threshold value. The route generation unit 116 determines the position of the merchandise to be purchased that is the closest to the current location of the user from among the merchandises to be purchased that are displayed in the area where the congestion degree is less than the threshold value, as a first point. The route generation unit 116 generates a route that connects the current location of the user to the first point and avoids the area where the congestion degree is the threshold value or more. Subsequently, the route generation unit 116 determines the position of the merchandise to be purchased that is the closest to the first point among the merchandises to be purchased that are displayed in the area where the congestion degree is less than the threshold value, as a second point. The route generation unit 116 generates a route that connects the first point to the second point and avoids the area where the congestion degree is the threshold value or more. The route generation unit 116 performs the same process on the remaining merchandises to be purchased.

The route generation unit 116 may generate a route using an order of the merchandises to be purchased that are displayed in the areas where the congestion degrees are the threshold value or more as an order after the merchandises to be purchased that are displayed in the area where the congestion degrees are less than the threshold value. The route generation unit 116 may determine an acquisition order of the merchandises to be purchased that are displayed in the area where the congestion degree is the threshold value or more in ascending order of the congestion degree in response to the congestion degree.

The route generation unit 116 may sequentially generate the route that avoids the areas where the congestion degree is the threshold value or more according to the acquisition order of the merchandises to be purchased.

With respect to the congestion degrees of the areas where the merchandises “bread”, “ham”, and “cheese” to be purchased by the user are displayed, a case where the area of the “bread” has “1”, the area of the “ham” has “2”, and area of the “cheese” has “1” is described with reference to FIG. 2. The threshold value of the congestion degree is “3”. For example, the route generation unit 116 compares the respective congestion degrees of the “bread”, the “ham”, and the “cheese” with the threshold value. The route generation unit 116 determines that the congestion degrees of the “bread”, the “ham”, and the “cheese” are less than the threshold value. The route generation unit 116 determines the “bread” displayed in the area that is the closest to the entrance that is the current location of the user from among the “bread”, the “ham”, and the “cheese” as the first point. The route generation unit 116 generates the route that connects the current location of the user to the first point and avoids the areas where the congestion degree is the threshold value or more. Subsequently, the route generation unit 116 determines the “cheese” displayed in the area close to the first point “bread” as the second point. The route generation unit 116 generates the route that connects the first point to the second point and avoids the areas where the congestion degree is the threshold value or more. In the example of FIG. 2, the route generation unit 116 generates the route that avoids the areas C-14 and C-15 where the congestion degree is the threshold value or more. Subsequently, the route generation unit 116 generates the route that connects the second point to the final point “ham” and avoids the areas where the congestion degree is the threshold value or more. Subsequently, the route generation unit 116 generates the route that connects the final point to the counter and avoids the areas where the congestion degree is the threshold value or more. In the example of FIG. 2, the route generation unit 116 generates the route that avoids the areas G-5, G-6, and G-7 where the congestion degree is the threshold value or more.

According to the example, the route generation unit 116 can generate the route based on the areas of the merchandises to be purchased and the congestion degree per area in the store. Accordingly, the route generation unit 116 can generate the route for acquiring the merchandises to be purchased while avoiding the areas with the high congestion degrees. Therefore, the server 1 can provide the merchandise purchase route based on the congestion state in the store. The user of the terminal 3 can acquire the merchandises to be purchased along the route that avoids the areas with the high congestion degrees.

In the example described above, the route generation unit 116 first determines the order for acquiring the merchandises to be purchased and determines the route, but the embodiment is not limited thereto. The route generation unit 116 may comprehensively determine route based on the current location of the user, the positions of the merchandises to be purchased, and the congestion degree.

The third acquisition unit 112 refers to the related merchandise information 132 and acquires the information relating to the related merchandise relating to the at least one merchandise to be purchased (ACT 105). In ACT 105, for example, the third acquisition unit 112 acquires the information relating to the related merchandises for the at least one merchandise to be purchased. The third acquisition unit 112 acquires the merchandise identification information of the related merchandises for each merchandise to be purchased. The third acquisition unit 112 may acquire the recommended information of the related merchandises for each merchandise to be purchased.

The second specifying unit 114 specifies the areas of the related merchandises from the area information 131 based on the information relating to the related merchandise acquired by the third acquisition unit 112 (ACT 106). In ACT 106, for example, the second specifying unit 114 refers to the area information 131 and acquires the display position information and the area identification information based on the merchandise identification information correlated with the related merchandises. The second specifying unit 114 specifies the areas of the merchandises to be purchased based on the area identification information.

The determination unit 115 determines the recommended merchandise from among the related merchandises based on the area of the related merchandise specified by the second specifying unit 114 and the congestion degree acquired by the second acquisition unit 111 (ACT 107). In ACT 107, for example, the determination unit 115 determines the recommended merchandise based on the congestion degrees correlated with the areas of the related merchandises.

In an example, the determination unit 115 compares the congestion degree of the area of the related merchandise with the threshold value. The determination unit 115 determines the recommended merchandise based on the comparison results between the congestion degrees of the areas of the related merchandises and the threshold value. The determination unit 115 determines the corresponding related merchandise as the recommended merchandise in response to the congestion degrees of the areas of the related merchandises which are less than the threshold value. Meanwhile, the determination unit 115 determines that the corresponding related merchandise is not the recommended merchandise in response to the congestion degrees of the areas of the related merchandises which are the threshold value or more.

According to the example, the determination unit 115 can determine the recommended merchandise from among the related merchandises based on the areas of the related merchandises and the congestion degree per area in the store. Accordingly, the determination unit 115 can determine the related merchandise displayed in the area where the congestion degree is not high as the recommended merchandise. Therefore, the server 1 can provide the recommended merchandise displayed in the area where the congestion degree is not high to the user of the terminal 3. The user of the terminal 3 can acquire the recommended merchandise along the route that avoids the areas with the high congestion degrees. Further, if the merchandise to be purchased is in the area with the high congestion degree, the user of the terminal 3 can avoid the areas with the high congestion degrees by moving to the position of the recommended merchandise.

In another example, the determination unit 115 determines the recommended merchandise in response to whether the area of the related merchandise specified by the second specifying unit 114 is within the predetermined field from the route. The determination unit 115 compares the congestion degree of the area of related merchandise with the threshold value. The determination unit 115 determines the merchandise to be recommended based on the comparison result between the congestion degree of the area of the related merchandise and the threshold value. The determination unit 115 determines the corresponding related merchandise as the merchandise to be recommended in response to the congestion degree of the area of the related merchandise which is less than the threshold value. Meanwhile, the determination unit 115 determines that the corresponding related merchandise is not the merchandise to be recommended in response to the congestion degree of the area of the related merchandise that is the threshold value or more. The determination unit 115 determines the merchandise to be recommended that is displayed in the area within the predetermined field from the route as the recommended merchandise based on the display position information of the merchandise to be recommended. The determination unit 115 determines that the merchandise to be recommended that is displayed in the area that is not within the predetermined field from the route is not the recommended merchandise.

According to the example, the determination unit 115 can determine the recommended merchandise in response to whether the area of the related merchandise is within the predetermined field from the route for acquiring the merchandise to be purchased. Accordingly, the determination unit 115 can determine the related merchandise displayed in the area close to the route as the recommended merchandise. Therefore, the server 1 can provide the recommended merchandise displayed in the area close to the route that avoids the areas with the high congestion degrees to the user of the terminal 3. The user of the terminal 3 can acquire the recommended merchandise along the route without passing the areas with the high congestion degrees.

The output unit 117 outputs the route generated by the route generation unit 116 and the information relating to the recommended merchandise determined by the determination unit 115 via the communication interface 14 to the terminal 3 (ACT 108). In ACT 108, for example, the output unit 117 outputs at least one of the route generated by the route generation unit 116 and the information relating to the recommended merchandise determined by the determination unit 115 to the terminal 3. The output unit 117 outputs the position of the recommended merchandise as the information relating to the recommended merchandise. In addition to the position of the recommended merchandise or instead of the position of the recommended merchandise, the output unit 117 may output the recommended information of the recommended merchandise. The processor 31 displays the at least one of the route and the information relating to the recommended merchandise to the display device 36.

The output unit 117 may output a message indicating that the area of the recommended merchandise has a low congestion degree as the information relating to the recommended merchandise. For example, if the congestion degree of the area of the merchandise to be purchased is the threshold value or more, the output unit 117 may output a message indicating that the area with the high congestion degree can be avoided by stopping by the area of the recommended merchandise as the information relating to the recommended merchandise.

The output unit 117 may output information relating to the recommended merchandise in any form such as symbols, icons, texts, voice, and moving images.

When outputting the route, the output unit 117 may change the necessity of the output of the information relating to the recommended merchandise in response to the congestion degree of the area of the at least one merchandise to be purchased. In an example, if the route generation unit 116 determines that the congestion degrees of the areas of all the merchandises to be purchased are less than the threshold value, the output unit 117 may display only the route generated by the route generation unit 116. In this case, the processes of ACTS 105 to 107 may be omitted. Accordingly, the server 1 can encourage the user of the terminal 3 to acquire the merchandise to be purchased without going out of the way while the congestion degree of the area of the merchandise to be purchased is low.

In another example, if the route generation unit 116 determines that the congestion degree of the area of the next merchandise to be purchased along the route from the current location of the user is the threshold value or more, the output unit 117 may output the information relating to the recommended merchandise. In the example, the output unit 117 may output the information relating to the recommended merchandise displayed in the area close to the route at least between the current location of the user and the area of the next merchandise to be purchased along the route. Accordingly, the server 1 can encourage the user of the terminal 3 to go out of the way until the user goes to the position of the merchandise to be purchased in the area with the high congestion degree. With respect to the congestion degree of the area of the merchandise to be purchased, it is likely that the congestion degree may decrease if the user of the terminal 3 reaches the position of the merchandise to be purchased according to the elapse of time.

If the route generation unit 116 determines that the congestion degrees of the areas of all the merchandises to be purchased are the threshold value or more, the route may be generated with the position of the recommended merchandise as the first point. In the example, the server 1 can provide the route for actively avoiding the areas with the high congestion degrees by guiding the user to the position of the recommended merchandise before the user moves to the position of the merchandise to be purchased that is in the area with the high congestion degree.

The route generation unit 116 may generate the shortest route based on the current location of the user and the display position information of the merchandise to be purchased. In this case, the output unit 117 displays the shortest route or the route that avoids the areas with the high congestion degrees according to the selection of the user of the terminal 3. In the example, the server 1 can provide the route according to the selection of the user.

The route generation unit 116 may update the route at the timing of detecting the current location of the user or the timing of acquiring the merchandise to be purchased by the user by using the sensors 2 or the beacon signals. The update process is the same as the process of the flowchart illustrated in FIG. 4. In the example, if the route that connects the current location of the user to the position of the merchandise to be purchased on the route updated by the route generation unit 116 passes the area where the congestion degree is the threshold value or more, the determination unit 115 may determine the related merchandise displayed on the route for avoiding the areas where the congestion degree is the threshold value or more as the recommended merchandise. The route generation unit 116 may generate the route that connects the current location of the user to the recommended merchandise as the first point. In the example, the server 1 can provide the route for avoiding the area with the high congestion degree that is updated according to the current location of the user.

### Second Embodiment

Hereinafter, a second embodiment is described with reference to the drawings.

The same configurations as the first embodiment are denoted by the same reference numerals, and the description thereof is omitted. In the second embodiment, mainly parts different from the first embodiment are described.

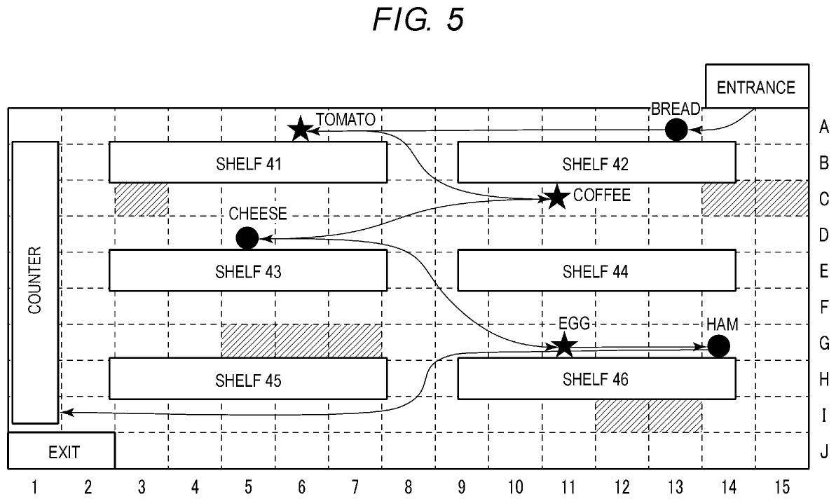

FIG. 5 is a diagram illustrating an example of the route according to the second embodiment.

FIG. 5 illustrates an example of the route displayed on the display device 36 of the terminal 3. The route displayed on the display device 36 is a route output by the output unit 117. The output unit 117 outputs the schematic diagram of the inside of the store including the route to the display device 36. The output unit 117 outputs the congestion degree per area to the display device 36 in an identifiable manner.

In the same manner as in FIG. 2, FIG. 5 illustrates the schematic diagram of the inside of the store, the areas with the high congestion degrees are identifiably indicated. In FIG. 5, black circles indicate the merchandises to be purchased by the user of the terminal 3. Stars indicate recommended merchandises determined by the determination unit 115. The recommended merchandises correspond to recommended merchandises to be output. For example, the route generation unit 116 generates the route for acquiring the merchandises to be purchased by the user and the recommended merchandises. In an example, the route generation unit 116 generates the route that connects the merchandises to be purchased to the points of the recommended merchandises and avoids the areas with the high congestion degree. In FIG. 5, the routes generated by the route generation unit 116 are indicated with arrows.

As a specific example, a case where the merchandises to be purchased by the user of the terminal 3 are “bread”, “ham”, and “cheese” is described. The third acquisition unit 112 acquires the information relating to the related merchandises of the “bread”, the “ham”, and the “cheese” that are the merchandises to be purchased. The determination unit 115 determines the related merchandises displayed in the areas where the congestion degree is not high from among the respective related merchandises as the recommended merchandises. In the example, the determination unit 115 determines the “tomatoes”, the “coffee”, and the “eggs” as the recommended merchandises. The route generation unit 116 generates the route for acquiring the “bread”, the “ham”, and the “cheese” that are merchandises to be purchased and the “tomatoes”, the “coffee”, and the “eggs” that are recommended merchandises. The route generation unit 116 generates the route that avoids the areas with the high congestion degree.

The route generation unit 116 determines the “bread” that is the merchandise displayed in an area that is the closest to the store entrance, which is the current location of the user, and in the area where the congestion degree is not high, from among the merchandises to be purchased and the related merchandises, as a first point. Subsequently, the route generation unit 116 determines the “tomatoes” displayed in the area that is close to the first point “bread” through the route that avoids the areas with the high congestion degree, as a second point. Here, the route generation unit 116 generates the route in which the “coffee” is not set as the second point but the “tomatoes” that does not pass the areas C-14 and C-15 is set as the second point in order to avoid the areas C-14 and C-15 where the congestion degree is high. Subsequently, the route generation unit 116 determines the “coffee” displayed in the area that is close to the second point “tomatoes” through the route that avoids the areas with the high congestion degree, as a third point. The route generation unit 116 generates the route that connects the second point “tomatoes” to the third point “coffee” through the route that avoids the areas with the high congestion degree. Subsequently, the route generation unit 116 determines the “cheese” displayed in the area that is close to the third point “coffee” through the route that avoids the areas with the high congestion degree, as a fourth point. The route generation unit 116 generates the route that connects the third point “coffee” to the fourth point “cheese” through the route that avoids the areas with the high congestion degree. Subsequently, the route generation unit 116 determines the “eggs” displayed in the area that is close to the fourth point “cheese” through the route that avoids the areas with the high congestion degree, as a fifth point. The route generation unit 116 generates the route that connects the fourth point “cheese” to the fifth point “eggs” through the route that avoids the areas with the high congestion degree. Subsequently, the route generation unit 116 determines the “ham” displayed in the area that is close to the fifth point “eggs” through the route that avoids the areas with the high congestion degree, as a sixth point. The route generation unit 116 generates the route that connects the fifth point “eggs” to the final point “ham” through the route that avoids the areas with the high congestion degree. The route generation unit 116 generates the route that is from the final point “ham” to the counter and avoids the areas with the high congestion degree. Here, the route generation unit 116 generates the route that does not pass the areas G-5, G-6, and G-7 in order to avoid the areas G-5, G-6, and G-7 with high congestion degrees. As described above, the route generation unit 116 generates the route that connects the points of the merchandises to be purchased of the “bread”, the “ham”, and the “cheese”, and the recommended merchandises of the “tomatoes”, the “coffee”, and the “eggs”, and avoids the areas with the high congestion degree. The route that is generated by the route generation unit 116 may be a route different from the shortest route that connects each of the points.

According to the example, the display device 36 can display the route for acquiring the merchandises to be purchased by the user and the recommended merchandises while avoiding the areas with the high congestion degree. Therefore, the user can acquire the merchandises along the route for avoiding the areas with the high congestion degrees. The display device 36 can display the recommended merchandises displayed in the areas where the congestion degrees are not high among the merchandises relating to the merchandises to be purchased by the user as the point on the route. Therefore, the user can acquire the recommended merchandises according to the route that avoids the areas with the high congestion degree even when being interested in the recommended merchandises. The route generation unit 116 can generate the route based on the areas of the merchandises to be purchased and the recommended merchandises and the congestion information. Therefore, the route generation unit 116 can generate the route for guiding the user to the points of the recommended merchandises, if the merchandises to be purchased by the user are displayed in the areas with the high congestion degrees.

The procedure of the processes by the information processing system S is described.

In the description with the server 1 as a subject, the server 1 may be read as the processor 11. In the same manner, in the description with the terminal 3 as a subject, the terminal 3 may be read as the processor 31. The processing procedure described below is merely an example, and each process may be changed as much as possible. In the processing procedure described below, steps can be appropriately omitted, substituted, or added in response to the embodiments.

Here, in the same manner as in the first embodiment, a case where the user of the terminal 3 intends to purchase “bread”, “ham”, and “cheese” in the store A that handles fresh foods such as a supermarket is assumed.

The server 1 performs the following information processes in response to the check-in by the user.

The procedure of the information processes by the server 1 is described.

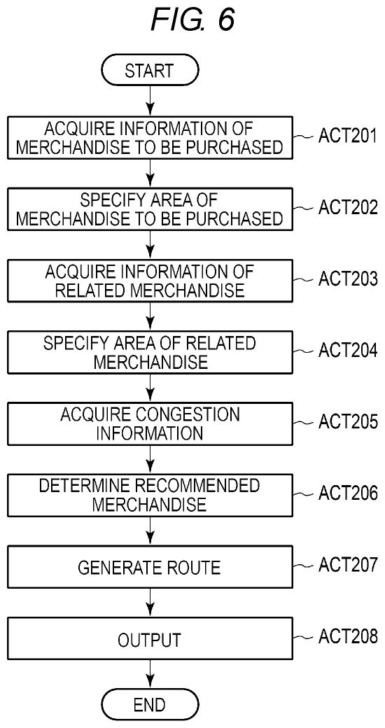

FIG. 6 is a flowchart illustrating the procedure of the information processes by the server 1 according to the second embodiment.

In the same manner as in ACT 101, the first acquisition unit 110 acquires the information relating to the at least one merchandise to be purchased based on the input by the user from the terminal 3 via the communication interface 14 (ACT 201).

In the same manner as in ACT 102, the first specifying unit 113 specifies the area of the at least one merchandise to be purchased based on the information relating to the at least one merchandise to be purchased that is acquired by the first acquisition unit 110 (ACT 202).

In the same manner as in ACT 105, the third acquisition unit 112 refers to the related merchandise information 132 and acquires the information relating to the related merchandises relating to the at least one merchandise to be purchased (ACT 203).

In the same manner as in ACT 106, the second specifying unit 114 specifies the areas of the related merchandises from the area information 131 based on the information relating to the related merchandises acquired by the third acquisition unit 112 (ACT 204).

In the same manner as in ACT 103, the second acquisition unit 111 refers to the congestion information 133 and acquires the congestion degree per area in the store (ACT 205).

The determination unit 115 determines the recommended merchandises from among the related merchandises based on the areas of the related merchandises specified by the second specifying unit 114 and the congestion degrees acquired by the second acquisition unit 111 (ACT 206). In ACT 206, for example, the determination unit 115 determines the recommended merchandises based on the congestion degree correlated with the areas of the related merchandises. The determination unit 115 compares the congestion degrees of the areas of the related merchandises with the threshold value. The determination unit 115 determines the recommended merchandises based on the comparison results between the congestion degrees of the areas of the related merchandises and the threshold value. The determination unit 115 determines the corresponding related merchandise as the recommended merchandise in response to the congestion degrees of the areas of the related merchandises that are less than the threshold value. Meanwhile, the determination unit 115 determines that the corresponding related merchandises are not the recommended merchandises in response to the congestion degrees of the areas of the related merchandises that are the threshold value or more.

The route generation unit 116 generates the route based on the area of at least one merchandise to be purchased specified by the first specifying unit 113, the area of the recommended merchandises determined by the determination unit 115, and the congestion degrees acquired by the second acquisition unit 111 (ACT 207). In ACT 207, for example, the route generation unit 116 compares the congestion degree of the area of at least one merchandise to be purchased with the threshold value. The route generation unit 116 determines an order of passing the positions of the merchandises to be purchased and the recommended merchandises based on the current location of the user detected by using the sensors 2 or the beacon signals, from among the merchandises to be purchased and the recommended merchandises that are displayed in the areas where the congestion degree is less than the threshold value. The route generation unit 116 determines the position of the merchandise that is the closest to the current location of the user as the first point, from among the merchandises to be purchased and the recommended merchandises which are displayed in the area where the congestion degree is less than the threshold value. The route generation unit 116 generates the route that connects the current location of the user to the first point and avoids the areas where the congestion degree is the threshold value or more. Subsequently, the route generation unit 116 determines the position of the merchandise to be purchased that is the closest to the first point as the second point, among the merchandises to be purchased and the recommended merchandises which are displayed in the areas where the congestion degree is less than the threshold value. The route generation unit 116 generates the route that connects the first point to the second point and avoids the areas where the congestion degree is the threshold value or more. The route generation unit 116 performs the same process on the remaining merchandises to be purchased and the remaining recommended merchandises.

The route generation unit 116 may generate the route by using the order of merchandises to be purchased that are displayed in the areas where the congestion degree is the threshold value or more as the order after the merchandises to be purchased and the recommended merchandises displayed in the areas where the congestion degree is less than the threshold value. The route generation unit 116 may determine the acquisition order of the merchandises to be purchased that are displayed in the areas where the congestion degree is the threshold value or more in an ascending order of the congestion degree, in response to the congestion degrees.

The route generation unit 116 may sequentially generate the route that avoids the areas where the congestion degree is the threshold value or more, according to the acquisition order of the merchandises to be purchased and the recommended merchandises.

With respect to the congestion degrees of the areas where the merchandises to be purchased by the user that are the “bread”, the “ham”, and the “cheese” are displayed, a case where the area of the “bread” has “1”, the area of the “ham” has “2”, and the area of the “cheese” has “1” is described with reference to FIG. 5. The threshold value of the congestion degree is “3”, The recommended merchandises determined by the determination unit 115 are the “tomatoes”, the “coffee”, and the “eggs”.

For example, the route generation unit 116 compares respective congestion degrees of the “bread”, the “ham”, and the “cheese” with the threshold value. The route generation unit 116 determines that the congestion degrees of the “bread”, the “ham”, and the “cheese” are less than the threshold value. The route generation unit 116 determines the “bread” displayed in the area that is the closest to the entrance, which is the current location of the user, as the first point, from among the “bread”, the “ham”, and the “cheese”, and the recommended merchandises which are “tomatoes”, the “coffee”, and the “eggs”. The route generation unit 116 generates the route that connects the current location of the user to the first point and avoids the areas where the congestion degree is the threshold value or more. Subsequently, the route generation unit 116 determines the “tomatoes” displayed in the area close to the first point “bread” as the second point. The route generation unit 116 generates the route that connects the first point to the second point and avoids the areas where the congestion degree is the threshold value or more. In the example of FIG. 5, the route generation unit 116 generates the route that avoids the areas C-14 and C-15 where the congestion degree is the threshold value or more. In the same manner, the route generation unit 116 sequentially generates the routes that connect the second point to the third point, the third point to the fourth point, the fourth point to the fifth point, and the fifth point to the final point, and avoid the areas where the congestion degree is the threshold value or more. Subsequently, the route generation unit 116 generates the route that connects the final point to the counter and avoids the areas where the congestion degree is the threshold value or more. In the example of FIG. 5, the route generation unit 116 generates the route that avoids the areas G-5, G-6, and G-7 where the congestion degree is the threshold value or more.

According to the example, the route generation unit 116 can generate the route based on the areas of the merchandises to be purchased, the areas of the recommended merchandises, and the congestion degrees per area in the store. Accordingly, the route generation unit 116 can generate the route for acquiring the merchandises to be purchased and the recommended merchandises while avoiding the areas with the high congestion degree. Therefore, the server 1 can provide the merchandise purchase route based on the congestion state in the store. The server 1 can add the recommended merchandises to the purchase route based on the congestion state in the store. The user of the terminal 3 can acquire the merchandises to be purchased and the recommended merchandise while avoiding the areas with the high congestion degree. Further, the route generation unit 116 can add the recommended merchandises displayed in the areas where the congestion degree is not high to the route. Accordingly, if the merchandises to be purchased are displayed in the area with the high congestion degree, or if the route that connects the positions of the merchandises to be purchased cannot avoid the areas with the high congestion degree, the route generation unit 116 generates the route that avoids the congestion by setting the recommended merchandises to be at the stop-by positions. Therefore, the server 1 can provide the merchandise purchase route that enables to actively avoid the areas with the high congestion degree. The user of the terminal 3 can acquire the merchandises to be purchased and the recommended merchandises according to the provided route while avoiding the areas with the high congestion degree.

In the examples described above, the route generation unit 116 first determines the order for acquiring the merchandises to be purchased and determines the route, but the embodiment is not limited thereto. The route generation unit 116 may comprehensively determine the route based on the current location of the user, the position of the merchandise to be purchased, and the congestion degree.

The output unit 117 outputs the route generated by the route generation unit 116 to the terminal 3 via the communication interface 14 (ACT 208). In ACT 208, for example, the output unit 117 may output the recommended information of the recommended merchandise in addition to the position of the recommended merchandise. The processor 31 displays the route on the display device 36.

The output unit 117 may output a message indicating that the area of the recommended merchandise has a low congestion degree as the information relating to the recommended merchandise. For example, if the congestion degrees of the areas of the merchandises to be purchased are the threshold value or more, the output unit 117 may output a message indicating that the areas with the high congestion degree can be avoided by stopping by the area of the recommended merchandise, as the information relating to the recommended merchandise.

The output unit 117 may output information relating to the recommended merchandise in any form such as symbols, icons, texts, voice, and moving images.

The route generation unit 116 may generate the shortest route based on the current location of the user, the display position information of the merchandises to be purchased, and the display position information of the recommended merchandises. In this case, the output unit 117 displays the shortest route or the route that avoids the areas with the high congestion degrees according to the selection of the user of the terminal 3. In the example, the server 1 can provide the route according to the selection of the user.

The route generation unit 116 may update the route at the timing of detecting the current location of the user by the sensor 2 or the timing for acquiring the merchandise to be purchased by the user. The update process is the same as the process of the flowchart illustrated in FIG. 6. In the example, if the route that connects the current location of the user to the positions of the merchandises to be purchased on the route updated by the route generation unit 116 passes the areas where the congestion degree is the threshold value or more, the determination unit 115 may determine the related merchandise displayed on the route for avoiding the areas where the congestion degree is the threshold value or more as the recommended merchandise. The route generation unit 116 may generate the route that connects the current location of the user to the recommended merchandise as the first point. In the example, the server 1 can provide the route for avoiding the areas with the high congestion degree that is updated according to the current location of the user. If the state of the recommended merchandise that is once notified to the user is changed, for example, if the route is updated, if the congestion degree of the recommended merchandise is changed to the threshold value or more, or the recommended merchandise is in a state of being out of the updated route, the display of the corresponding recommended merchandise may be maintained without being deleted from the schematic diagram of the inside of the store which is displayed on the display device 36.

As described above with an example of the server 1, the information processing device may be realized with one device or may be realized by a system in which the functions are distributed to a plurality of devices.

All or a part of the units described to be installed in the processor 11 of the server 1 may be installed in the processor 31 of the terminal 3. If an output unit that is the same as the output unit 117 is installed in the processor 31, the output unit includes a unit that displays the route on the display device 36.

The program may be transferred in a state of being stored in the electronic device or may be transferred in a state of not being stored in the electronic device. In the latter case, the program may be transferred via the network or may be transferred in a state of being recorded on a recording medium. The recording medium is a non-temporary tangible medium. The recording medium is an electronic device readable medium. As long as the recording medium is a medium that can store a program such as a CD-ROM or a memory card and can be read by an electronic device, the form thereof is not limited.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of at least one embodiment described herein may be made without departing from the spirit of the disclosure. The accompanying claims and their equivalents are intended to cover such forms or modifications as would fall within the scope and spirit of the disclosure.

What is claimed is:

1. An information processing device comprising:
at least one processor configured to:
acquire, in a first acquisition, information relating to at least one merchandise to be purchased based on input of a user;
specify, in a first specifying, an area of the at least one merchandise to be purchased based on the information relating to the at least one merchandise to be purchased that is acquired in the first acquisition;
acquire, in a second acquisition, congestion information per area in a store;
generate a route based on the area of the at least one merchandise to be purchased that is specified in the first specifying and the congestion information that is acquired in the second acquisition; and
output the route that is generated.

2. The device according to claim 1, the at least one processor further configured to:
acquire, in a third acquisition, information relating to related merchandises relating to the at least one merchandise to be purchased;
specify, in a second specifying, areas of the related merchandises based on the information relating to the related merchandises that are acquired in the third acquisition;
determine a recommended merchandise from among the related merchandises based on the areas of the related merchandises that are specified in the second specifying and the congestion information that is acquired in the second acquisition; and
output information relating to the determined recommended merchandise.

3. The device according to claim 2,
wherein the at least one processor is configured to determine the recommended merchandise in response to whether the areas of the related merchandises that are specified in the second specifying are within a predetermined field from the route.

4. An information processing device comprising at least one processor configured to:
acquire, in a first acquisition, information relating to at least one merchandise to be purchased based on input of a user;
specify, in a first specifying, an area of the at least one merchandise to be purchased based on information relating to the at least one merchandise to be purchased that is acquired in the first acquisition;
acquire, in a second acquisition, congestion information per area in a store;
acquire, in a third acquisition, information relating to related merchandises relating to the at least one merchandise to be purchased;
specify, in a second specifying, an area of the related merchandise based on the information relating to the related merchandise that is acquired in the third acquisition;
determine a recommended merchandise from among the related merchandises based on the areas of the related merchandises specified in the second specifying and the congestion information that is acquired in the second acquisition;
generate a route based on the area of the at least one merchandise to be purchased that is specified in the first specifying and an area of the determined recommended merchandise, and congestion information that is acquired in the second acquisition; and
output the route that is generated.

5. An information processing system comprising at least one processor configured to:
acquire, in a first acquisition, information relating to at least one merchandise to be purchased based on input of a user;
specify, in a first specifying, an area of the at least one merchandise to be purchased based on the information relating to the at least one merchandise to be purchased that is acquired in the first acquisition;
acquire, in a second acquisition, congestion information per area in a store;
generate a route based on the area of the at least one merchandise to be purchased that is specified in the first specifying and the congestion information that is acquired in the second acquisition; and
output the route that is generated.

6. The device according to claim 1, wherein the at least one processor comprises a server.

7. The device according to claim 1, wherein the information relating to at least one merchandise to be purchased includes registered merchandise information.

8. The device according to claim 1, wherein the congestion information includes a density of customers.

9. The device according to claim 1, wherein the generating a route includes generating a route to avoid high congestion.

10. The device according to claim 9, wherein the high congestion is in areas having congestion above a threshold value.

11. The device according to claim 1, wherein the generated route is different from a shortest route.

12. The device according to claim 1, wherein the at least one processor is configured to output the generated route to a terminal.

13. The device according to claim 12, wherein the terminal is one of a smartphone or a tablet terminal.
